(19) United States
(12) Patent Application Publication
(10) Pub. No.: US 2013/0246141 A1
(43) Pub. Date: Sep. 19, 2013

(54) DISRUPTIVELY PRICED OR FREE FINANCIAL SERVICES OR ITEMS IN EXCHANGE FOR PARTICIPATION IN OPT IN ADVERTISING

(71) Applicant: Michael A. Liberty, Windermere, FL (US)

(72) Inventor: Michael A. Liberty, Windermere, FL (US)

(21) Appl. No.: 13/874,192

(22) Filed: Apr. 30, 2013

Related U.S. Application Data
(63) Continuation-in-part of application No. 13/528,720, filed on Jun. 20, 2012.
(60) Provisional application No. 61/641,677, filed on May 2, 2012.
(60) Provisional application No. 61/499,927, filed on Jun. 22, 2011.

(51) Int. Cl. G06Q 30/02

(52) U.S. Cl. CPC G06Q 30/0215
USPC 705/14.17

(57) ABSTRACT

An electronic payment system is provided which provides monetary rewards in exchange for participation in opt-in advertising. The electronic payment system is configured to receive an indication that a user is initiating participation in opt-in advertising. The advertising is sent to the user from the electronic payment system in exchange for a monetary reward. In most cases, the user will have a mobile wallet account at the electronic payment system. The electronic payment system then sends advertisements to a mobile wallet application running on a digital device of the user, determines an appropriate monetary reward based on the number and/or type of advertisements sent to the user's mobile wallet application, and provides the determined monetary reward to the user via the mobile wallet application on the user's digital device.

### CROSS-REFERENCE TO RELATED APPLICATIONS

This application claims priority to and the benefit of U.S. Provisional Patent Application Ser. No. 61/641,677, entitled “Providing Monetary Incentives in Exchange for Participation in Opt-In Advertising”, filed on May 2, 2012. This application also claims priority to and is a continuation-in-part of U.S. patent application Ser. No. 13/528,720, entitled “Disruptively Priced or Free Financial Services or Items in Exchange for Participation in Opt-In Advertising”, filed on Jun. 20, 2012, which itself claims priority to and the benefit of U.S. Provisional Application Ser. No. 61/499,927, filed on Jun. 22, 2011, entitled “Disruptively Priced or Free Financial Services or Items in Exchange for Participation in Opt In Advertising”, which is incorporated herein by reference in its entirety. This application further claims priority to and the benefit of U.S. patent application Ser. No. 13/484,199, entitled “Monetary Transaction System”, filed on May 30, 2012, which itself claims priority to U.S. Provisional Application Ser. No. 61/522,099, filed on Aug. 10, 2011, entitled “Mobile Wallet Platform”, and U.S. Provisional Application Ser. No. 61/493,064, filed on Jun. 3, 2011, entitled “Mobile Wallet Platform”. Each of the aforementioned applications is incorporated by reference herein in its entirety.

### BACKGROUND

Mobile phones and other digital devices have become increasingly popular in recent years. Many mobile device users use their devices to perform countless different daily tasks. For instance, mobile devices allow users to check email, send and receive instant messages, check calendar items, take notes, set up reminders, browse the internet, play games or perform any number of different actions using specialized applications or “apps”. These applications allow mobile devices to communicate with other computer systems and perform a wide variety of network-connected tasks previously not possible with a mobile device.

### BRIEF SUMMARY

Embodiments described herein are directed to providing disruptively priced or free financial services or items in exchange for participation in opt-in advertising. A user may opt-in to receive some form of advertising on his or her phone. The advertising may appear in a mobile wallet application used to pay for goods or services. The advertising may be related to products the user has previously purchased using the mobile wallet application. The user has an account with a mobile payment system that provides the mobile wallet application. The mobile payment system can provide the user with a variety of functionality including purchasing items along with one or more of depositing funds, withdrawing funds, transferring funds, etc. Accordingly, the user can use a digital device (e.g., a computer or mobile phone) to interact with the electronic payment system to pay for goods and/or services.

In exchange for a financial benefit, the user opts in to receive advertisements, coupons, vouchers, promotions, Buy One Get One (“BOGO”) offers or other benefits from the electronic payment system. Upon the user's agreement to participate in opt-in advertising, the electronic payment system may be permitted to store (e.g., by capturing purchase orders), track, and analyze items that the user purchases through their account with the electronic payment system. The electronic payment system stores and maintains a list of a user's purchased items in a data warehouse. The electronic payment system then analyzes the user's purchasing habits to identify advertisements and/or promotions that may be of interest to the user. The promotions (such as coupons) may then be sent to the user's mobile wallet application and applied automatically when the user purchases that item using the mobile wallet.

In other embodiments, an electronic payment system may be provided which provides monetary rewards in exchange for participation in opt-in advertising. For instance, the electronic payment system may be configured to receive an indication that a user is initiating participation in opt-in advertising. The advertising is sent to the user from the electronic payment system in exchange for a monetary reward. In most cases, the user will have a mobile wallet account at the electronic payment system. The electronic payment system then sends advertisements to a mobile wallet application running on a digital device of the user, determines an appropriate monetary reward based on the number and/or type of advertisements sent to the user's mobile wallet application, and provides the determined monetary reward to the user via the mobile wallet application on the user's digital device.

In yet another embodiment, an electronic payment system may be provided which allows users to redeem monetary rewards received for participation in opt-in advertising. The electronic payment system receives an indication from a user's mobile wallet application that a user is attempting to pay for a good or service using monetary rewards received in exchange for participation in opt-in advertising. In most cases, as above, the user will have a mobile wallet account at the electronic payment system. The electronic payment system then validates the user's mobile wallet account to ensure that the user's mobile wallet account has sufficient funds, including the monetary rewards, to pay for the specified good or service, and applies of the monetary rewards to the indicated good or service, allowing the user to purchase the indicated good or service using the received monetary rewards. In some cases, the electronic payment system may receive a subsequent indication from the user's mobile wallet application indicating that a coupon is to be applied for the purchase of the good or service. The electronic payment system may then determine whether the coupon applies to the indicated good or service and, if so, may apply the coupon to the indicated good or service, so that the user purchases the indicated good or service using the received monetary rewards at a price reduced by the amount of the coupon.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 illustrates a monetary transaction system architecture in which embodiments described herein may operate.

FIG. 2 illustrates an alternate example embodiment of a monetary transaction system.

FIGS. 3A and 3B illustrate example data flows for performing subscriber-to-subscriber and subscriber-to-non-subscriber eMoney transfers via a mobile wallet, respectively.

FIG. 4 illustrates an example data flow for making a retail purchase using a mobile wallet.

FIG. 5 illustrates a monetary transaction system architecture in which free or reduced price items may be provided in exchange for opt-in advertising.

FIG. 6 illustrates an example data flow for providing free or reduced price items in exchange for participation in opt-in advertising.

FIG. 7 illustrates an example screen shot of a mobile wallet application with opt-in advertisements.

FIG. 8 illustrates an example data flow for providing monetary rewards in exchange for participation in opt-in advertising.

FIG. 9 illustrates an example data flow for redeeming a monetary reward received for participation in opt-in advertising.

### DETAILED DESCRIPTION

Embodiments described herein are directed to providing disruptively priced or free financial services or items in exchange for participation in opt-in advertising. A user may opt-in to receive some form of advertising on his or her phone. The advertising may appear in a mobile wallet application used to pay for goods or services. The advertising may be related to products the user has previously purchased using the mobile wallet application. The user has an account with a mobile payment system that provides the mobile wallet application. The mobile payment system can provide the user with a variety of functionality including purchasing items along with one or more of depositing funds, withdrawing funds, transferring funds, etc. Accordingly, the user can use a digital device (e.g., a computer or mobile phone) to interact with the electronic payment system to pay for goods and/or services.

In exchange for a financial benefit, the user opts in to receive advertisements, coupons, vouchers, promotions, Buy One Get One (“BOGO”) offers or other benefits from the electronic payment system. Upon the user's agreement to participate in opt-in advertising, the electronic payment system may be permitted to store (e.g., by capturing purchase orders), track, and analyze items that the user purchases through their account with the electronic payment system. The electronic payment system stores and maintains a list of a user's purchased items in a data warehouse. The electronic payment system then analyzes the user's purchasing habits to identify advertisements and/or promotions that may be of interest to the user. The promotionsz (such as coupons) may then be sent to the user's mobile wallet application and applied automatically when the user purchases that item using the mobile wallet.

In other embodiments, an electronic payment system may be provided which provides monetary rewards in exchange for participation in opt-in advertising. For instance, the electronic payment system may be configured to receive an indication that a user is initiating participation in opt-in advertising. The advertising is sent to the user from the electronic payment system in exchange for a monetary reward. In most cases, the user will have a mobile wallet account at the electronic payment system. The electronic payment system then sends advertisements to a mobile wallet application running on a digital device of the user, determines an appropriate monetary reward based on the number and/or type of advertisements sent to the user's mobile wallet application, and provides the determined monetary reward to the user via the mobile wallet application on the user's digital device.

In yet another embodiment, an electronic payment system may be provided which allows users to redeem monetary rewards received for participation in opt-in advertising. The electronic payment system receives an indication from a user's mobile wallet application that a user is attempting to pay for a good or service using monetary rewards received in exchange for participation in opt-in advertising. In most cases, as above, the user will have a mobile wallet account at the electronic payment system. The electronic payment system then validates the user's mobile wallet account to ensure that the user's mobile wallet account has sufficient funds, including the monetary rewards, to pay for the specified good or service, and applies of the monetary rewards to the indicated good or service, allowing the user to purchase the indicated good or service using the received monetary rewards. In some cases, the electronic payment system may receive a subsequent indication from the user's mobile wallet application indicating that a coupon is to be applied for the purchase of the good or service. The electronic payment system may then determine whether the coupon applies to the indicated good or service and, if so, may apply the coupon to the indicated good or service, so that the user purchases the indicated good or service using the received monetary rewards at a price reduced by the amount of the coupon.

Embodiments described herein may comprise or utilize a special purpose or general-purpose computer including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computer system. Computer-readable media that store computer-executable instructions in the form of data are computer storage media. Computer-readable media that carry computer-executable instructions are transmission media. Thus, by way of example, and not limitation, embodiments described herein can comprise at least two distinctly different kinds of computer-readable media: computer storage media and transmission media.

Computer storage media includes RAM, ROM, EEPROM, CD-ROM, solid state drives (SSDs) that are based on RAM, Flash memory, phase-change memory (PCM), or other types of memory, or other optical disk storage, magnetic disk storage or other magnetic storage devices, or any other medium which can be used to store desired program code means in the form of computer-executable instructions, data or data structures and which can be accessed by a general purpose or special purpose computer.

A “network” is defined as one or more data links and/or data switches that enable the transport of electronic data between computer systems and/or modules and/or other electronic devices. When information is transferred or provided over a network (either hardwired, wireless, or a combination of hardwired or wireless) to a computer, the computer properly views the connection as a transmission medium. Transmission media can include a network which can be used to carry data or desired program code means in the form of computer-executable instructions or in the form of data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”), and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that various embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. Embodiments described herein may also be practiced in distributed system environments where local and remote computer systems that are linked (either by hardwired data links, wireless data links, or by a combination of hardwired and wireless data links) through a network, each perform tasks (e.g. cloud computing, cloud services and the like). In a distributed system environment, program modules may be located in both local and remote memory storage devices.

In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

For instance, cloud computing is currently employed in the marketplace so as to offer ubiquitous and convenient on-demand access to the shared pool of configurable computing resources. Furthermore, the shared pool of configurable computing resources can be rapidly provisioned via virtualization and released with low management effort or service provider interaction, and then scaled accordingly.

A cloud computing model can be composed of various characteristics such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth. In this description and in the claims, a “cloud computing environment” is an environment in which cloud computing is employed.

Additionally or alternatively, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), and other types of programmable hardware.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

Various terminology will be used herein to describe the monetary transaction system (also referred to as a “mobile wallet platform”, “mobile wallet program”, “mobile wallet transaction system”, “mobile financial services (mFS) platform” or “electronic payment system”). The term “agent” is used to refer to an individual with mFS transaction system tools and training to support specific mFS functions. These mFS functions include subscriber registration and activation, and the deposit and withdrawal of funds from the mFS transaction system. Agents are representatives of the mFS transaction system or “program”. Agents can be employees or contractors of the program provider, or other companies and organizations that partner with the program provider to provide these services themselves. Agents may be found in every facet of a typical economy, and may include large retailers, mobile network operators (MNO) airtime sales agents, gas stations, kiosks, or other places of business.

The mobile wallet platform includes a mobile wallet application, web interface or some other type of functionality that allows the user to interact with the mFS platform using their mobile device. The mobile wallet application may include a subscriber identity module (SIM) application, an Unstructured Supplementary Service Data (US SD) application, a smartphone application, a web application, a mobile web application, a Wireless Application Protocol (WAP) application, a Java 2 Platform, Micro Edition (J2ME) application, a tablet application or any other type of application or interface that provides tools for the agent to register, activate, and offer other services to the mFS subscriber.

As used herein, a mobile wallet application is a mobile wallet application installed on a SIM card. A USSD application is an application that implements USSD for various functionality including prepaid callback service, location-based content services, menu-based information services and other mobile wallet platform services. A web application is one that implements or uses the internet to provide mobile wallet platform functionality. A mobile web application is similar to a web application, but is tailored for mobile devices. A WAP application is one that uses the wireless application protocol to communicate with the mobile wallet platform to provide the platform's functionality. A J2ME application is an application developed in Java and is designed to provide mobile wallet functionality on a variety of different hardware. A tablet application is an application specifically designed for a touchscreen-based tablet that provides mobile wallet platform functionality for tablet devices, and as part of configuring the phone on the network. Any of these applications (or any combination thereof) may be provided on the user's mobile device. This functionality can also be made available on a retail point of sale (POS) system or web site.

The term “agent administrator” refers to an individual with mFS program tools and training to administrate the allocation of funds to agent branches (e.g. retail locations). As agents perform mFS transactions with subscribers, such as depositing and withdrawing money, the agents are adding and removing money from their own accounts. Any of the applications referred to above may be configured to provide tools used by the agent administrator to view the agent company balance, view the agent branch balances, and transfer funds into and out of agent branch mobile wallets. This functionality can also be made available on a website for easier access.

In some embodiments, the mFS platform application may utilize triple data encryption standard (3DES) encryption (or some other type of encryption), encrypted message signing, and password security on some or all of its communications with the mFS transaction system in order to ensure that the transactions are properly secured and authenticated.

The term “agent branch” refers to any location where an agent provides support for subscriber services of the mFS platform. Funds are allocated by the agent administrator from the agent company's main account to each agent branch to fund the subscriber mFS functions such as depositing or withdrawing cash, in-store purchases, bill payments, prepaid airtime top-ups and money transfers. In some cases, multiple agents may work in a single branch. However, at least in some cases, monetary funds are allocated to from the agent company's main account on a per branch basis.

The term “agent branch account balance” refers to the amount of money residing in a particular agent branch account at a given time. Funds can be deposited into the branch account by the agent administrator, or the funds can come from participating in subscriber mFS transactions such as depositing or withdrawing cash from the subscriber's mobile wallet accounts, or making retail purchases with the mobile wallet.

In some embodiments, in countries with more developed economies, it may be beneficial to use program-issued pre-paid debit cards, pre-paid access accounts, stored value accounts or gift cards to conduct business along with the added convenience of card processing networks such as Cirrus, STAR, or Visa for POS and automated teller machine (ATM) functionality. Agents, particularly those in retail outlets and kiosks, can still support subscribers with deposits, withdrawals, and other transfers, but in this case bank external card processors manage the mobile wallet and branch account balances and provide the real-time transfer of funds.

The term “agent branch ledger” refers to a written (or electronic) ledger maintained by the mFS platform. Agent branch transactions are performed on the agent's and subscriber's mobile phones where an electronic record of the transaction is generated and stored on the mFS platform. These electronic transactions are then reconciled with agent branch ledgers to ensure the security and integrity of the transaction. Agent branch ledgers are printed or electronic transaction logs that are distributed to the agent branch locations in hard copy form to serve as a backup record to the electronic transactions.

The term “agent company” refers to a business that registers to participate in the mFS program as a partner of the mFS program provider or owner. The agent company has one or more agent branches which conduct mFS business with mFS program subscribers. In some cases, the agent company may be referred to as a distributor or retailer.

The term “agent company account balance” refers to the sum of the funds deposited at a “partner bank” (defined below) by the agent company to fund the agent company's daily transactions. The funds in the agent company account are then distributed to agent branches by the agent company's agent administrator to conduct everyday business such as accepting cash deposits and cash withdrawals from mFS subscribers. This balance is sometimes referred to as the “agent company float”.

An “agent manager” is a supervisor of company agents for a given company. The agent manager has the training and tools to create, delete or modify agent accounts for a company, as well as monitor the transactions performed by agents. The agent manager may have a special application or an increased level of rights to access applications features not available to other users. The special application is a program installed on the agent manager's terminal. This application provides the agent manager the ability to securely perform agent manager functions such as registering and activating new agent accounts. The mFS agent manager application may be installed on any terminal or device. It communicates with the mFS platform using binary and/or text SMS messages. A wireless service provider or MNO provides the GSM SMS network infrastructure on which the mFS platform operates.

As subscribers, agents, and other mFS program participants conduct business in the mFS program, value is transferred from one account to the next as payment for services rendered or goods purchased. This value can be in the form of real currency or the electronic representation referred to herein as eMoney. Among other situations, eMoney is used in mFS implementations where the real-time processing of financial transactions including card processing is not practical. The mFS platform utilizes an internal transaction processor for managing the real-time balance of mobile wallet and agent accounts as value (eMoney) is transferred from one mobile wallet to another in payment for services.

The term “mFS program master account” refers to a bank account maintained by the mFS program partner bank to provide funds and float for the operation of the mFS platform. Depending on the type of mFS implementation, the master account can include sub-accounts for each of the agent branches and subscriber mobile wallets, giving the bank visibility into all transactions on a per-user basis. The mFS platform can also manage the balance of sub-accounts and interact with the bank's master account when funds need to be deposited or withdrawn from the account.

The term mobile network operator (MNO) refers to a provider of mobile phone service including basic voice, SMS, unstructured supplementary service data (USSD) and data service, and may also be referred to as a “wireless service provider”.

The term “mobile wallet” or “mobile wallet account” refers to a stored value account or prepaid access account (PPA) that allows the owner (or “subscriber”) to pay for goods and services on the mFS platform from his or her mobile wallet account. When the mFS eMoney transaction processor is used, the mobile wallet balance is maintained by the mFS platform and value is exchanged within the mFS program as eMoney. When the mFS platform is integrated to an external card processor, the mobile wallet utilizes funds from the subscriber's prepaid debit card and bank account to exchange value on the mFS platform.

The term “partner bank” refers to the primary bank participating in the mFS program. The partner bank is responsible for holding the mFS program master accounts that hold the funds for all mFS services and transactions. A “PIN” refers to a numeric password that may be required to perform a transaction via the mobile wallet application.

The term “subscriber” refers to a participant of the mFS mobile wallet platform. The subscriber maintains a mobile wallet balance and performs transactions using the mFS application. An “unbanked subscriber” is a subscriber that does not have (or does not have access to) a bank account or credit union account. The application or “mobile wallet application” provides mobile wallet functionality to the (unbanked) subscriber. The mobile wallet application is installed on a mobile device in the device's memory, on a SIM card (such as a GSM SIM card) or is otherwise accessible to the mobile device. The mobile wallet application provides the subscriber the ability to securely perform subscriber functions such as making retail purchases, paying bills, or transferring money to other mFS subscribers and non-subscribers. The mobile wallet application communicates with the mFS platform using binary and text SMS messages, among other forms of wireless communication. A wireless service provider or MNO provides the GSM network infrastructure on which the mFS platform operates.

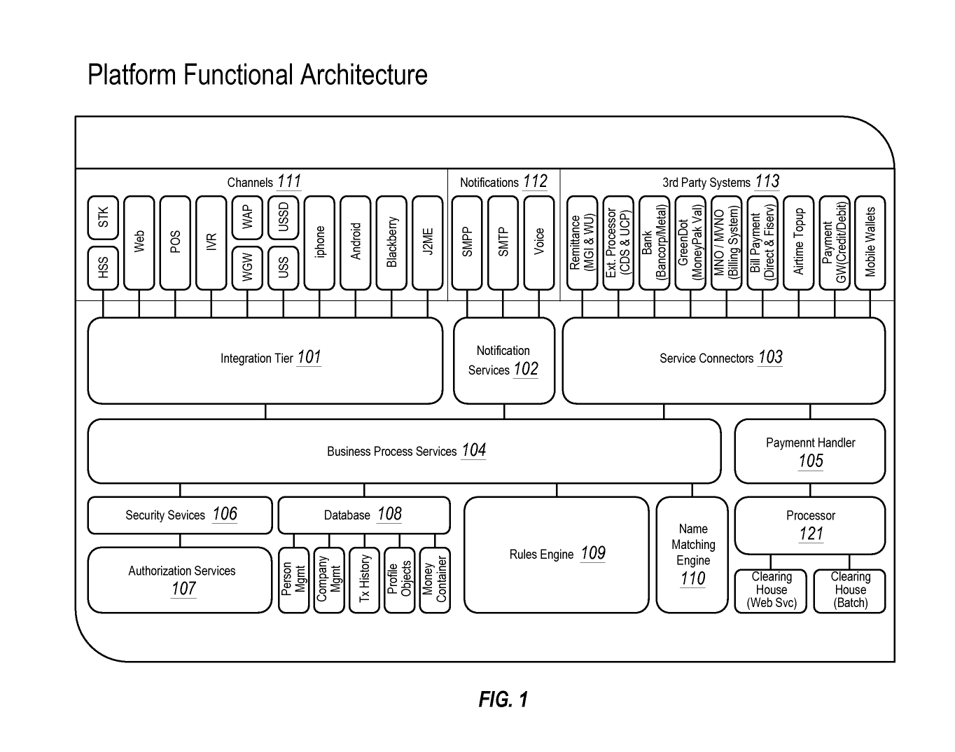

FIG. 1 illustrates an example system architecture for a mobile wallet platform. Integration tier 101 is configured to manage mobile wallet sessions and maintain integrity of financial transactions. Integration tier 101 can also include a communication (e.g., Web services) API and/or other communication mechanisms to accept messages from channels 111. Other mechanisms include, but are not limited to: International Standards Organization (“ISO”) 8583 for Point of Sale (“POS”) and Automated Teller Machines (“ATM”) devices and Advanced Message Queuing Protocol (“AMQP”) for queue based interfaces. Each of channels 111 can be integrated to one or more mechanisms for sending messages to integration tier 101. Notification services 102 is configured to send various notifications through different notification channels 112, such as, for example, Short Message Peer-to-Peer (“SSMP”) for Short Messaging Service (“SMS”) and Simple Mail Transfer Protocol (“SMTP”) for emails. Notification services 102 can be configured through a web services API.

Service connectors 103 are a set of connectors configure to connect to 3rd party systems 113. Each connector can be a separate module intended to integrate an external service to the system architecture. Business process services 104 are configured to implement business workflows, including executing financial transactions, auditing financial transactions, invoking third-party services, handling errors, and logging platform objects. Payment handler 105 is configured to wrap APIs of different payment processors, such as, for example, banking accounts, credit/debit cards or processor 121. Payment handler 105 exposes a common API to facilitate interactions with many different kinds of payment processors.

Security services 106 are configured to perform subscriber authentication. Authorization services 107 are configured to perform client authorization, such as, for example, using a database-based Access Control List (“ACL”) table.

Database 108 is configured to manage customer accounts (e.g., storing customer accounts and properties), manage company accounts (e.g., storing company accounts and properties), manage transaction histories (e.g., storing financial transaction details), store customer profiles, storing dictionaries used by the mobile wallet platform, such as, for example, countries, currencies, etc., and managing money containers. Rules engine 109 is configured to gather financial transaction statistics and uses the statistics to provide transaction properties, such as, for example, fees and bonuses. Rules engine 109 is also configured to enforce business constraints, such as, for example, transactions and platform license constraints.

Name matching engine 110 is configured to match different objects according to specified configuration rules. Matching engine 110 can be use to find similarities between names, addresses, etc. Transaction processor 121 is configured to manage financial accounts and transactions. The transaction processor 121 can be used to hold, load, withdraw and deposit funds to mobile wallet accounts. Transaction processor 121 can also be used as a common interface to a third party processor system. When used as a common interface, financial operations may be delegated to the external processor. A Clearing House subsystem of transaction processor 121 can be used to exchange the financial information with a bank.

Components of a mobile wallet platform can be connected to one another over (or be part of) a system bus and/or a network. Networks can include a Local Area Network (“LAN”), a Wide Area Network (“WAN”), and even the Internet. Accordingly, components of the mobile wallet platform can be “in the cloud”. As such, mobile wallet platform components as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the system bus and/or network.

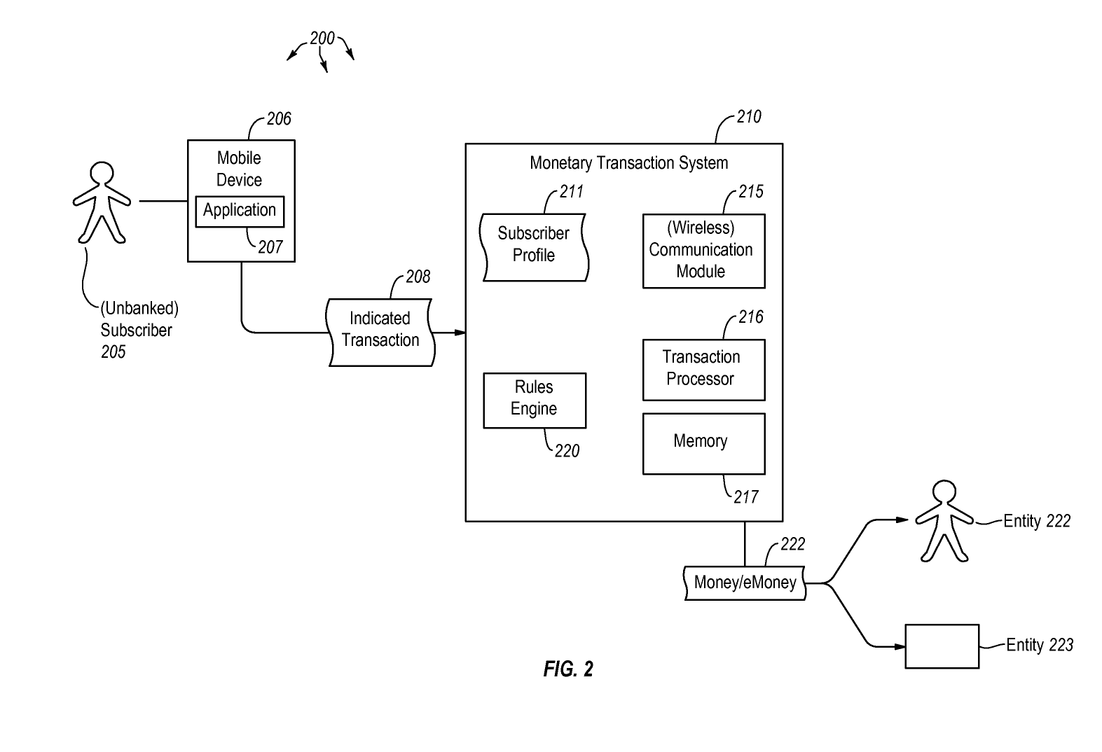

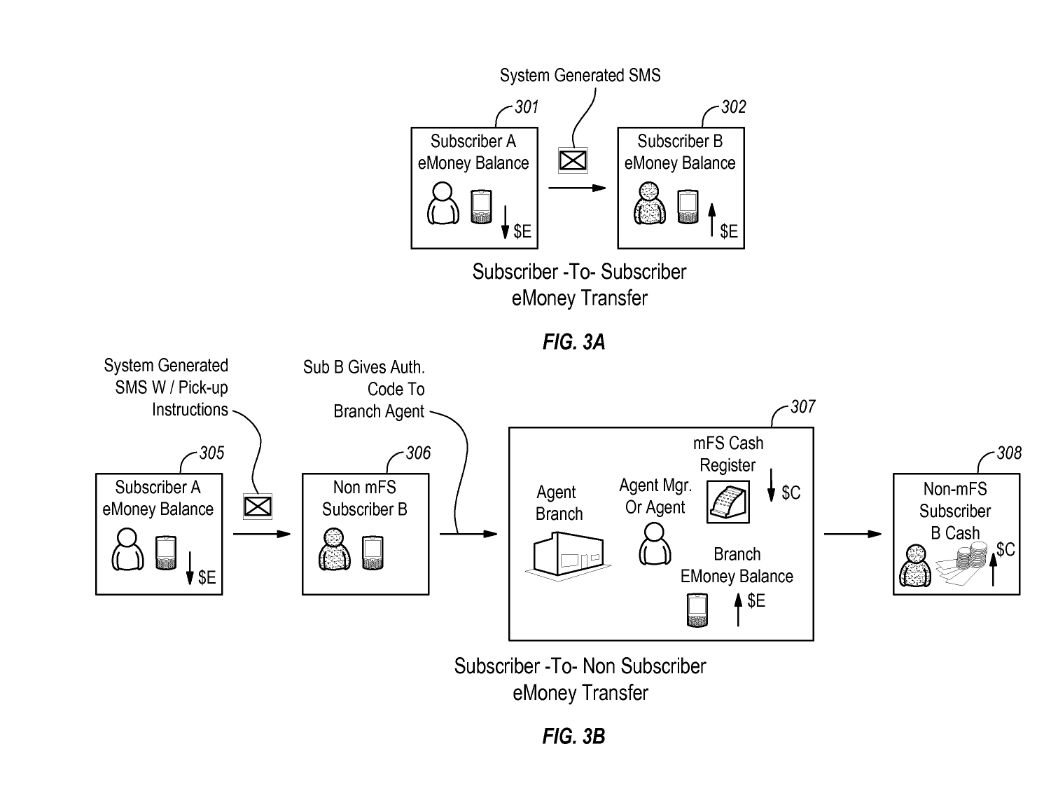

The components depicted in FIG. 1 can interoperate to provide a number of financial and other services including but not limited to enrolling a customer for a mobile wallet, adding a stored value account (either hosted by a mobile wallet platform or a third party), adding a bank or credit union account to a mobile wallet, adding a debit or credit card account to a mobile wallet, depositing funds in a mobile wallet, withdrawing funds from a mobile wallet, paying bills from a mobile wallet, topping up a prepaid mobile account through a mobile wallet, transferring funds through a mobile wallet (nationally or internationally), making in-store purchases using a mobile wallet, and various other tasks as described herein below. These services will be described in greater detail below with regard to system FIGS. 1 and 2, as well as FIGS. 3-19B.

FIG. 2 depicts a monetary transaction system 200 similar to that described in FIG. 1. The monetary transaction system 200 may provide a more simplified system structure in which each of the above services may be provided. The system includes a subscriber 205. The subscriber may have access to a bank account, or may be an unbanked subscriber. The subscriber has a profile 211 with the monetary transaction system 210. The profile includes the subscriber's know your customer (KYC) information, as well as any associated bank accounts, credit union accounts, bill pay accounts or other accounts. The subscriber has (or has access to) a mobile device 206 such as a phone or tablet. The mobile device runs the mobile wallet application (or mobile wallet application) 207.

The subscriber can indicate, using the mobile application 207 which transaction or other action he or she would like to perform. The indicated transaction 208 is sent to the mobile wallet platform 210 to be carried out by the platform. The transaction processor 216 (which may be similar to or the same as transaction processor 121 of FIG. 1) performs the transaction(s) specified by the (unbanked) subscriber 205. The transaction processor may implement various other components to perform the transaction including memory 217, (wireless) communication module 215, rules engine 210 and/or transaction database 225.

Performing the specified transactions may include communicating with the monetary transaction database 225 to determine whether the transaction is permissible based on data indicated in the unbanked subscriber's profile (for instance, whether the subscriber has enough eMoney in his or her stored value account, or has enough money in his or her bank account). Rules engine 220 may also be consulted to determine whether the subscriber has exceeded a specified number of allowed transactions. Then, if funds are available, and the transaction is otherwise permissible, the monetary transaction system can transfer money or eMoney 221 to or from an entity such as a user or agent (e.g. entity 222) to or from an establishment such as a retail store or agent company (e.g. entity 223).

In some cases, the monetary transaction system 210 application provides a web interface that allows subscribers to perform the same functions provided by the monetary transaction system application. For instance, mobile wallet application 207 may provide a web interface that allows a user to enroll for a mobile wallet. The web interface (or the mobile wallet application itself) receives a subscriber-initiated transaction over one of a plurality of channels (111 from FIG. 1) connected to the monetary transaction system 210. The web interface or mobile wallet application may prompt for and receive enrollment information (e.g. KYC information) for the (unbanked) subscriber 205 over at least one of the plurality of channels (e.g. web, point-of-sale (POS), interactive voice response (IVR, etc.). The web interface or mobile wallet application may then send activation instructions over the same or a different channel to activate the (unbanked) subscriber 205 and create a subscriber account for the (unbanked) subscriber.

Once the subscriber has an account, the monetary transaction system generates a corresponding mobile wallet for the unbanked subscriber (available via the web interface and/or the mobile wallet application. The system then presents the (unbanked) subscriber's account data associated with the mobile wallet and/or a notification indicating that enrollment was successful to the subscriber. Accordingly, the mobile wallet application or the web interface may be used to provide user enrollment functionality. It should also be understood that either the mobile wallet application or the web interface may be used to provide substantially all of the mobile wallet functionality described herein.

It should also be noted that the mobile device 206 may be any type of plan-based phone or tablet, or prepaid phone or tablet. Many subscribers, such as unbanked subscribers, may primarily use prepaid phones. The mobile wallet application 207 may be installed on both plan-based phones and prepaid phones. The mobile wallet application may be installed on the device's SIM card, or on the device's main memory. Accordingly, the monetary transaction system 200 may be accessed and used via substantially any type of plan-based or prepaid mobile device.

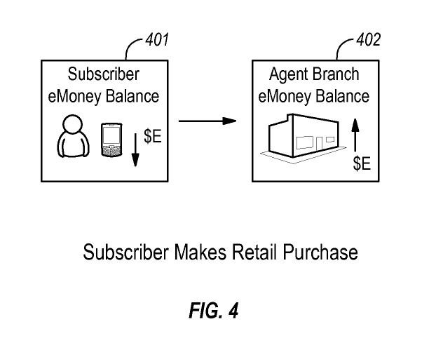

The components depicted in FIG. 1 can interoperate to provide a number of financial and other services including but not limited to enrolling a customer for a mobile wallet, adding a stored value account (either hosted by an electronic payment system or a third party), adding a bank/credit union account to a mobile wallet, adding a debit/credit card account to a mobile wallet, depositing funds in a mobile wallet, withdrawing funds from a mobile wallet, paying bills from a mobile wallet, topping up a prepaid mobile account through a mobile wallet, transferring funds through a mobile wallet, making in store purchases from a mobile wallet, or transferring money or eMoney from one business account to another business account (i.e. from one business's mobile vault to another business's mobile vault, as will be shown in FIG. 4).

FIG. 3A depicts a subscriber-to-subscriber eMoney transfer. In a merchant and distributor scenario, either or both of the merchant and the distributor (including any delivery personnel) may be subscribers. To perform such a transfer, subscriber A (301) enters some type of identification information identifying subscriber B (e.g. subscriber B's phone number) and an amount of money he or she wishes to transfer. The transaction processor 216 of the monetary transaction system 210 determines if there are sufficient funds to complete the transfer. If sufficient funds are available, the monetary transaction system 210 decrements subscriber A's account and credits subscriber B's account (302). The system then sends some kind of notification (e.g. SMS) to subscriber B indicating that a certain amount of money was transferred to their account. Subscriber A may also receive a notification that the transfer was successful. Accordingly, eMoney may be transferred between two mFS platform subscribers, one or both of which may be unbanked. The monetary transaction system 210 processes the subscribers' requests, updates the subscribers' eMoney balances, logs the transactions, and sends transaction information to a specified bank when needed.

FIG. 3B illustrates a subscriber-to-non-subscriber eMoney transfer. Accordingly, as mentioned above, either or both of the merchant and the distributor may be non-subscribers. In graphic 305, subscriber A wishes to send eMoney to another individual that is not a subscriber to the mFS platform. The transaction is initiated in the same fashion as the subscriber-to-subscriber transfer scenario. However, since non-subscriber B does not have a mobile wallet account, the monetary transaction system 210 cannot credit them with eMoney. Instead, the monetary transaction system 210 sends a notification (e.g. via SMS) to non-subscriber B with instructions for how to pick-up the transferred money, along with an authorization code (306). The monetary transaction system 210 puts a hold on subscriber A's account for the amount transferred. Subscriber B then has a specified number of days to pick up the cash before the hold expires and the amount is credited back to subscriber A's eMoney account by the monetary transaction system 210.

When non-subscriber B goes to pick up the money at an agent branch, the agent branch's manager or agent verifies the authorization code via an agent manager or agent mobile wallet application (that, in turn, accesses the mFS platform). Once the transfer has been validated, the agent gives the cash to non-subscriber B. The agent branch's mFS account is credited with the transfer amount (307) and the user leaves with the cash in hand (308). The mFS platform processes the transfer request, updates subscriber A's eMoney balance, logs the transaction, and sends transaction details to a platform-specified bank.

FIG. 4 illustrates a mobile wallet subscriber making a retail purchase. Mobile wallet subscribers can make retail purchases at agent branches directly from their mobile device. Agent branches, as explained above, are retail stores or other entities that have registered with the mFS system and are able to accept mobile wallet payments. Accordingly, a subscriber can select the items they wish to purchase, and indicate (via the mobile wallet application) to the agent branch that they wish to pay for the items. The mobile wallet application then communicates with the agent branch and the monetary transaction system to indicate the price of the transaction. The monetary transaction system 210 then debits the subscriber's eMoney account (401) and credits the agent branch's eMoney account (402). The agent branch (and/or the agent manager or agent) receives confirmation that subscriber paid for the purchase. The subscriber may also receive a summary of the retail purchase and may be asked to confirm the purchase by entering a PIN. The monetary transaction system processes the purchase request, updates the agent branch and subscriber's eMoney balances, logs the transaction, and sends transaction details to a mFS platform-specified bank.

In one embodiment, the monetary transaction system 210 is implemented to make a purchase from a mobile wallet. The communications module 215 of the monetary transaction system 210 receives a communication from a subscriber over a communication channel 111. The subscriber communication indicates that an unbanked subscriber 205 desires to purchase an item for a specified amount of funds using a specified payment method from the unbanked subscriber's mobile wallet.

The monetary transaction system 210 then returns a secure, perishable purchase code to the unbanked subscriber over at least one of the channels connected to the monetary transaction system and receives a subsequent agent branch communication over a channel indicating that the purchase code has been presented to an agent (branch). The monetary transaction system 210 validates the status of the specified payment method, determines if the specified payment method can accommodate a purchase for the specified amount, performs a limit check and/or a velocity check on the selected payment method, debits the specified payment method by the specified amount of funds, returns a notification to the agent branch authorizing the purchase and sends a receipt to the unbanked subscriber over a communication channel. The monetary transaction system 210 may thus be used in this manner to make a retail purchase using a mobile wallet.

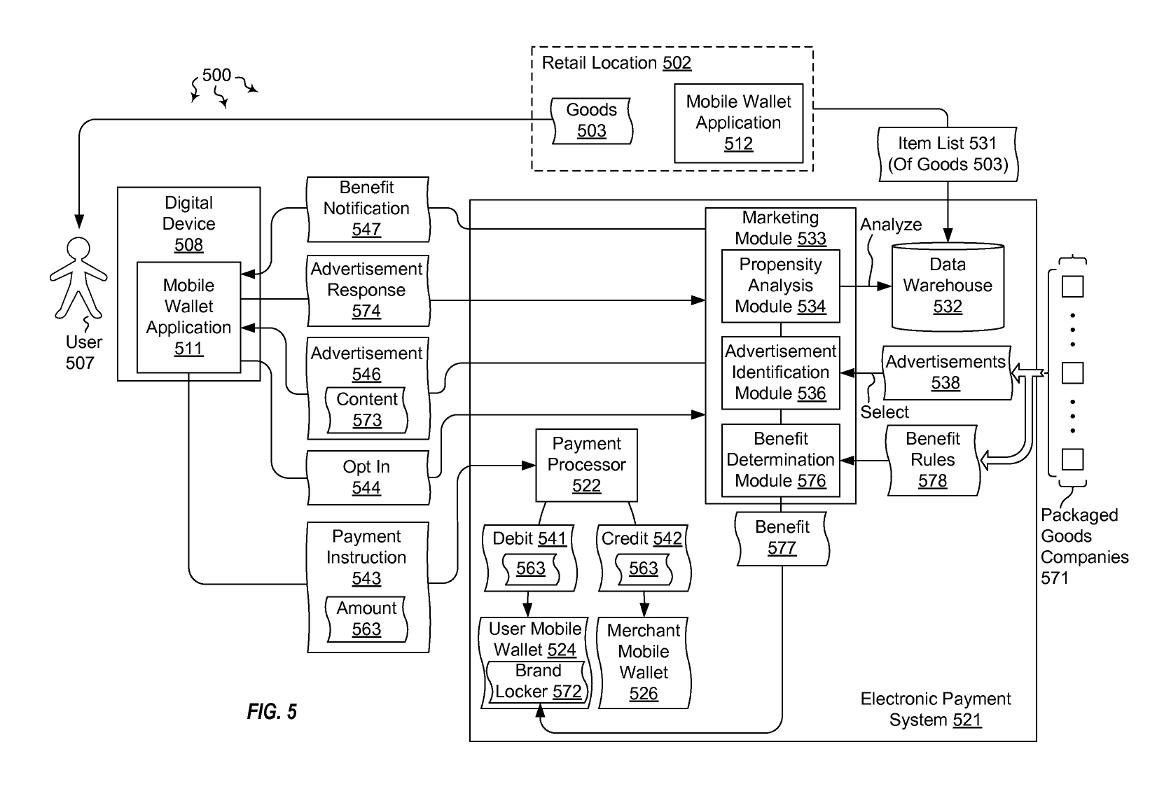

FIG. 5 depicts a physical environment and corresponding computer system architecture 500 for providing disruptively priced or free financial services or items in exchange for participation in opt-in advertising. The environment 500, like the scenarios described in FIGS. 3A, 3B and 4, involves the use of a mobile wallet application 511. The mobile wallet application 511 can be used to provide disruptively priced or free financial services or items in exchange for participation in opt-in advertising. The mobile wallet application may be run on any type of digital device including a mobile phone, tablet, laptop or other digital device. Embodiments include providing digital data (e.g., coupons or vouchers) for obtaining disruptively priced or free items (e.g., consumer goods or groceries) to such digital devices.

In some embodiments, a user has an account with a mobile payment system. The mobile payment system (e.g. 210 of FIG. 2 or 521 of FIG. 5) can provide the user 507 with a variety of functionality including purchasing items (see FIG. 4), depositing funds, withdrawing funds, transferring funds (see FIGS. 3A and 3B), etc. Accordingly, the user can use a digital device to interact with the electronic payment system 521 to pay for goods and/or services.

In exchange for some type of financial benefit, the user opts in to receive advertisements. The financial benefits may include coupons, vouchers, promotions, Buy One Get One (“BOGO”) offers or any other type of benefit (such as a reduced cost or free financial service or good) from the electronic payment system. The benefit may be targeted to the user based on the user's age, location or other demographic information, or based on the user's past purchases. At least in some embodiments, when the user agrees to participate in opt-in advertising, the electronic payment system 521 is permitted to store (e.g., by capturing purchase orders), track, and analyze items that the user purchases through their account with the electronic payment system. The electronic payment system stores and maintains lists of the users' purchased items in a data warehouse. The electronic payment system may also store information about the user (anonymous or otherwise) including age, income level, an indication of whether kids are in the family, or other information that may be useful in targeting ads or benefits to the user.

The electronic payment system analyzes 534 the users purchasing habits to identify advertisements and/or promotions that may be of interest to the user. The advertisements and/or promotions can be for items the user has purchased 503. The advertisements and/or promotions can also be for items related to items the user has purchase. For example, if user has purchased a particular brand of razor, advertisements for the brand's shaving cream can be identified. Advertisements for related items can also be used for cross-promotion.

From time to time, at specified intervals, or based on location (e.g., having a coupon for a merchant this is with a specified proximity) the electronic payment system sends identified advertisements and/or promotions to the user's digital device. When specified advertising thresholds are satisfied (e.g., a specified number and/or type of advertisements and/or promotions are presented), the electronic payment system confers a financial benefit on the user's account. For example, the electronic payment system can provide the user's account with a low cost (e.g., reduced fee) or free financial service, such as, for example, one reduced cost bill pay or one free bill pay. Alternately, the electronic payment system can provide the user's account with a coupon or voucher for an item (e.g., an item a user has pre-selected or an item the user has purchased in the past).

In some embodiments, a client application for the electronic payment system runs on the user's digital device (e.g. mobile wallet application 511). The user interacts with the electronic payment system through the client application. From a screen of the client application, the user can agree to accept opt in advertising. Accordingly, embodiments of the invention essentially permit a user to self-monetize themselves through their digital device.

As further depicted in FIG. 5, computer architecture 500 includes digital device 508, retail location 502, and electronic payment system 521. Digital device 508 further includes mobile wallet application 511. Retail location 502 further includes its own mobile wallet application 512. Electronic payment system 521 includes marketing module 533, data warehouse 532, advertisements 538, payment processor 522, user mobile wallet 524 (user 507's mobile wallet), and merchant mobile wallet 526 (retail location 502's mobile wallet).

Generally, each company in packaged goods companies 571 (or retailers that sell the packaged goods or other goods or services) can send advertisement data to electronic payment system 521. Advertisements 538 represent the collection of advertisement data sent from packaged goods companies 571. Each company in packaged goods companies 571 can also submit benefit rules to electronic payment system 521. Benefit rules 578 represent the collection of benefit rules sent from packaged goods companies 571. Benefit rules 578 define when a benefit, such as, for example, a free financial service, a coupon, a promotion, etc, is to be granted to a user of electronic payment system 521. For example, in response to completing a questionnaire linked to a product advertisement, a user can be given a coupon for the product or for a related product.

In general, user 507 can use mobile wallet application 511 to pay for goods purchased at retail location 502 (as shown in FIG. 4). For example, user 507 can use mobile wallet application 511 to purchase goods 503. To pay for goods 503, mobile wallet application 511 can send payment instruction 543 in amount 563 to electronic payment system 521. Payment processor 522 can receive payment instruction 543. In response, payment processor 522 can debit 541 user mobile wallet 524 by amount 563. Payment processor 522 can also credit 542 merchant mobile wallet 526 by amount 563.

User 507 can use mobile wallet application 511 to participate in opt-in advertising. For example, user 507 can use mobile wallet application 511 to send opt-in 544 to electronic payment system 521. Advertising module 533 can receive opt-in 544 and record that mobile wallet application 511 has opted in for advertising. As such, when user 507 makes a purchase using mobile wallet application 511, a list of purchased items is sent to electronic payment system 521. For example, upon purchasing goods 503, item list 531 is sent to electronic payment system 521 and stored in data warehouse 532.

Propensity analysis module 534 can analyze user 507's purchases, including item list 531. From the analysis, propensity analysis module 534 can identify items or categories of items user 507 may be interested in. The items can be items user 507 has purchased in the past (e.g., an item in goods 503) or items related to items user 507 has purchases in the past. Propensity analysis module 534 can indicate identified items or categories of items to advertisement identification module 536. These identified items or categories are items that the user is likely interested in and, as such, may have a propensity toward buying these items. The propensity analysis module may use past purchases, personal preferences, lifestyle or demographic information or other data in the propensity analysis.

Advertisement identification module 536 can then select advertisements from advertisements 538 that correspond to the identified items or categories of items. For example, advertisement identification module 536 can select advertisement 546 for presentation at mobile wallet application 511. Advertisement 546 can be an advertisement for a product made by a company in packaged goods companies 571. Additionally or alternatively, the advertisement 546 may be created by the merchant and may advertise products or services sold by that merchant.

Advertising module 533 can send selected advertisements to mobile wallet application 511. For example, advertising module 533 can send advertisement 546 (e.g., related to an item in goods 503) to mobile wallet application 511. In general, advertisements can include interactive content. For example, advertisement 546 includes content 573. Content 573 can be a video, a link to a company website (e.g., for a company in packaged goods companies 571), a call to action (such as a questionnaire), or some other content user 507 can interact with through digital device 508. User 507 can interact with content 573, for example, responding to questions in content 573. Advertisement response 574 can indicate how user 507 has interacted with content 573. In one embodiment, a call to action may be to post an update on Facebook® or some other website such as a retail establishment ranking website. If the user makes such a post or performs some other call to action, the user may be rewarded with a benefit. That benefit may be related to the product about which the user posted on the various websites.

Based on advertisement response 574, benefit determination module 576 can determine if a benefit is to be conferred upon user 507. Benefit determination module 576 can refer to benefit rules 578 when making a determination whether or not to confer a benefit. Thus, when user 507 interacts with advertisement 546 in a specified way (e.g., completes a survey, watches a video, etc.), benefit rules 578 can indicate that a company benefit (e.g., benefit 577) is to be conferred upon user 507. For example, benefit determination module 576 can confer benefit 577 on user 507. When user 507 receives an advertisement for a razor, for instance, and answers a questionnaire on how often they shave, a razor manufacture can give user 507 a coupon for reduced cost or free razor blades.

When a benefit is to be conferred on a user, the benefit can be stored in the user's brand locker. For example, benefit determination module 576 can store benefit 577 in brand locker 572 (part of user mobile wallet 524). Benefit 577 can be a coupon, a reduced cost or free financial service, a voucher, a promotion, a free bill pay, etc.

Benefit determination module 576 can also track aggregate statistics, such as, for example, specified number and/or type of advertisements received, for advertisements presented at mobile wallet application 511. Benefits can also be conferred upon users based on the aggregate statistics. For example, benefit determination module 576 can confer a benefit upon user 507 in response to twenty advertisements being presented at mobile wallet application 511. Thus, conferred benefits can be company-specified benefits or can be electronic payment system-specified benefits. Electronic payment system 521 can notify a user when a benefit is conferred. For example, electronic payment system 521 can send benefit notification 547 to mobile wallet application 511 to indicate benefit 577 being stored in brand locker 572.

When user 507 makes subsequent purchases through user mobile wallet 524, electronic payment system 521 can automatically check brand locker 572 for benefits related to any purchases items. If benefits for an item are identified, user 507 can be notified through mobile wallet application 511. In some cases, if benefits are identified, those benefits can be applied automatically when the user purchases that item or service. Thus, if the benefit is a coupon or a buy one get one free offer, that benefit may be applied automatically when the user uses his or her mobile wallet application 511 to purchase that item. Accordingly, embodiments of the invention permit user 507 to self monetize digital device 508 through agreeing to participate in opt-in advertising.

Although not depicted, various other modules from the architecture of FIG. 1 or 2 can also be included electronic payment system 521. The modules expressly depicted in FIG. 5 can interoperate with these other modules as appropriate to facilitate desired functionality.

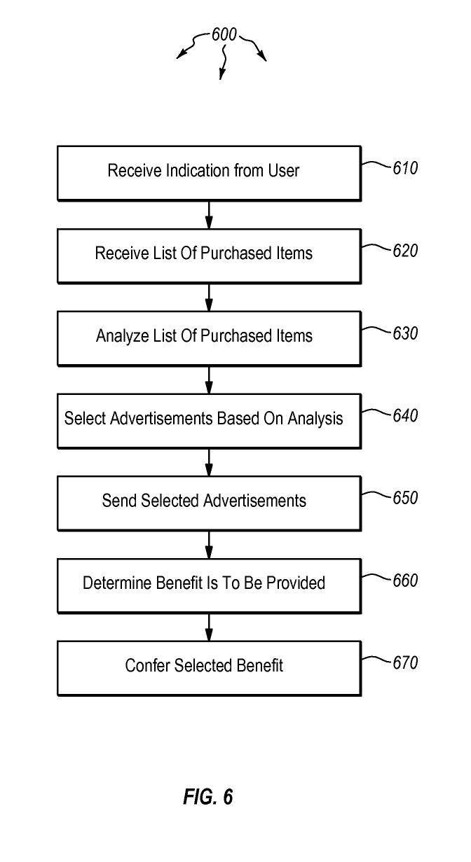

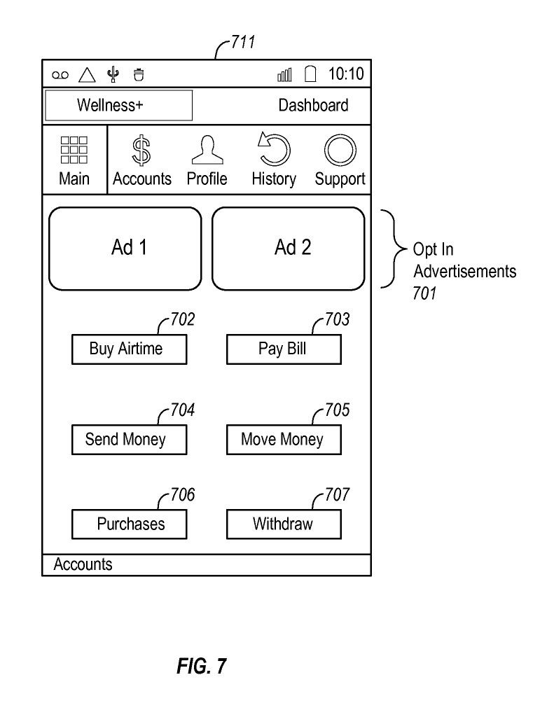

In one embodiment, as shown in FIG. 6, a method 600 for providing reduced cost or free services or goods in exchange for participation in opt-in advertising is described. This method is further described in conjunction with the electronic payment system 521 of FIG. 5, as well as the example screenshot of a mobile wallet application 711 illustrated in FIG. 7.

Method 600 includes receiving an indication that user 507 is opting in to receive opt-in advertising from electronic payment system 521 in exchange for a reduced cost or free financial service (step 610). The user has a mobile wallet account 524 with the electronic payment system 521. Next, method 600 includes receiving a list of one or more items 531 that the user has purchased using the mobile wallet account 524 (step 620) and analyzing 534 the list of items to identify items or item categories in which the user may be interested (and which the user may have a propensity toward buying) (step 630). Method 600 further includes selecting one or more advertisements 546 based on the identified items or item categories (step 640) and sending the selected advertisements to mobile wallet application 511 (which is tied to the user's mobile wallet account 524) for use by the user (step 650). Method 600 then includes determining that the user's interactions 574 with the selected advertisements 543 warrant conferring a benefit 577 to the user 507 (step 660), where the benefit is selected from among a reduced cost or free financial service, a coupon, a voucher, and a buy one get one free offer, and then conferring the selected benefit 577 upon the user by sending the benefit to the user's mobile wallet application 511 (step 670).

After the benefit has been conferred upon the user, the user may use the benefit when purchasing a corresponding product or service. Accordingly, as shown in FIG. 7, for example, if Ad 1 or Ad 2 (701) shows a name brand diaper and the user interacts with the ad in some way, the company that produces the diaper may send a coupon or other benefit to the user's mobile wallet 511. Then, when the user is at a retail location (e.g. 502), the user may purchase that name brand diaper using their mobile wallet (e.g. using the “Purchases” button 706). The coupon or other benefit sent by the diaper producer will be automatically applied at checkout, such that the user obtains the diapers for a discounted price. Many different coupons or other benefits may be stored in the user's brand locker 572, and each of these may be applied automatically when the electronic payment system 521 determines that the user is purchasing that product or service.

Still further, as mentioned above, the user may use their mobile wallet application 711 to perform other tasks such as adding airtime to their phone (702), paying a bill (703), sending money to another party (704), transferring money (705) or withdrawing money (707) at an agent branch, for example. Many other functions may be provided by the mobile wallet application. As such, buttons 702-707 are merely examples of possible buttons. Moreover, the look and feel of mobile wallet application 711 may be as illustrated in FIG. 7, or may be substantially different, or may be modified by the user. Accordingly, the layout shown in FIG. 7 is just one example of a possible button and advertisement layout. Many such layouts are possible, and may be different for each phone or digital device.

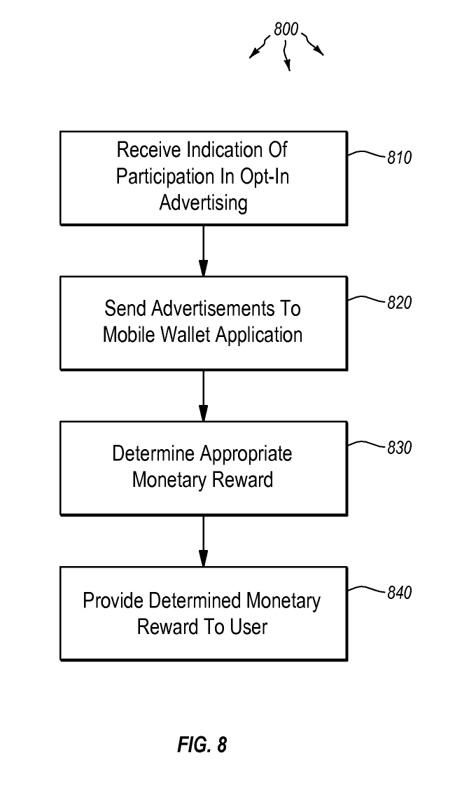

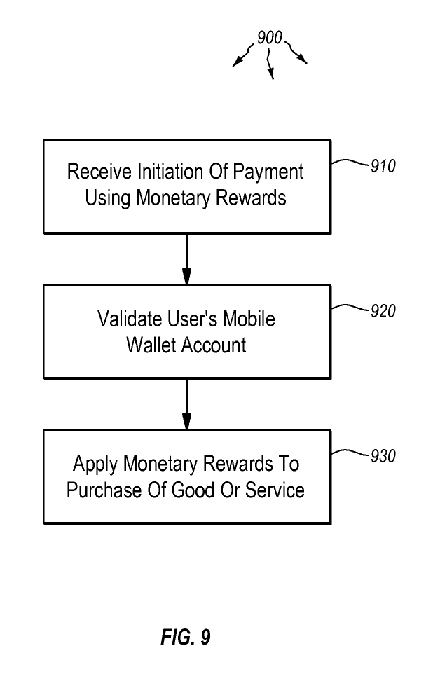

Thus, using the electronic payment system 521, a user may opt in to receive opt-in advertising. Then, after receiving that advertising (and possibly after interacting with it), the user may be conferred a benefit. This benefit may be used to receive reduced cost or free financial services or goods. The benefit may be applied automatically as the user is purchasing that good or service. At least in some cases, as will be described below in conjunction with FIGS. 8 and 9, the benefit may be a monetary reward.

The electronic payment system 521 of FIG. 5 may be used to provide the monetary rewards. The monetary rewards may be sent as part of, or may be referred to with the other rewards, coupons and other benefits 577 described above. In some cases, the monetary rewards may be sent in lieu of other benefits such as coupons or buy-one-get-one-free offers. The monetary rewards may be calculated by the benefit determining module 576, as will be explained further below. In one embodiment, as described in FIG. 8, a method 800 is provided for providing monetary rewards in exchange for participation in opt-in advertising.

Method 800 includes an act of receiving at the electronic payment system an indication that a user 507 of is initiating participation in opt-in advertising 546 sent from the electronic payment system 521 in exchange for a monetary reward 577, the user having a mobile wallet account 524 at the electronic payment system (act 810). In response, the electronic payment system 521 may send one or more advertisements 546 to a mobile wallet application 511 running on a digital device 508 of the user 505 (act 820). The electronic payment system 521 then determines an appropriate monetary reward 577 based on the number and/or type of advertisements 546 sent to the user's mobile wallet application 511 (act 830) and provides the determined monetary reward 577 to the user via the mobile wallet application 511 on the user's digital device 508 (act 840).

Once the monetary reward has been provided, the electronic payment system 521 may send a benefit notification 547 notifying the user 507 that the monetary reward is available. The monetary reward may be sent to one of the user's debit 541 or credit 542 accounts, or may be sent to another value store on (or accessible by) the mobile wallet application 511. The monetary rewards may be cash, credit or other forms of monetary value. The monetary rewards are sent to the user 507 after the user has opted in 544 to receive advertisements on their digital device 508 (either within the mobile wallet application 511 or one the user's device in some manner). In some cases, the benefit determination module 576 may analyze the user's interaction with the advertisement (e.g. determine whether the user has clicked on a corresponding web link, or watched a video, or otherwise interacted with the ad 546) and increase or decrease the user's monetary rewards accordingly. Thus, if a user views and interacts with more ads, the user may receive more monetary rewards.

In some cases, the electronic payment system 521 may receive a list of items that a user has purchased using the mobile wallet account 524. The electronic payment system 521 may then analyze the list of items 531 (along with other items purchased by the user in the past) to identify items or categories of items the user is likely interested in. The advertisement identification module 536 may then select one or more advertisements that correspond to the determined items or categories of items. Thus, if a user appears to be interested in energy drinks, basketball shorts, ebooks, or any number of other goods or services, the advertisements sent to the user may be tailored to their interests. As such, goods and services producers (e.g. 571) may be able to directly target their ads to users that are interested in their products, and may further provide those users monetary rewards for viewing their ads, or at least for allowing the advertiser's ads to be shown on their digital devices.

Demographic information may be requested of and provided by the user 507. The demographic information may include age, marital status, education level, ethnicity, or other types of demographic information. The user may determine whether to provide demographic information and which types of demographic information they want to provide. This information may be used by the advertisers and/or by the advertisement identification module 536 in determining which ads are to be shown to the user. In some cases, the user may provide an increased amount of personal data to receive an increased amount of monetary rewards. Some advertisers may pay more money for ads that are shown to people of certain demographics (e.g. males 18-24). If a user identifies himself as such a person, he may be able to receive a larger monetary reward as part of his agreement to participate in opt-in ads. In some cases, users may be given monetary rewards based on a percentage of the amount paid by the advertiser. For instance, if an advertiser paid to advertise on the mobile wallets of certain users (e.g. user 507) or users of certain demographics, and the user received those ads, the user may be given a small percentage of the amount paid by the advertiser. In some cases, the advertisements may be sold at auction and the user may receive a specified percentage of the advertisement's selling price. A user may thus be able to receive a larger monetary reward by allowing more ads (or more targeted ads based on demographic information) to be shown on their digital device.

In some cases, a monetary reward may be customized based on the user's current location. For instance, if a user is in the United States, the reward may be given in dollars. If a user is in Mexico, the reward may be given in pesos, in an amount that is equivalent or at least related to the amount given in dollars. In some cases, producers may pay more for advertisements in certain countries, or in certain locations (e.g. states) within those countries. In such cases, the user may receive larger or smaller rewards depending on where they are currently located (according to GPS, device settings or other information). In some embodiments, the user 507 may not have a debit or credit account with a bank or credit card company. In such cases, the user may receive the monetary rewards in a value store associated with their mobile wallet account 524. If the user uses their mobile wallet to purchase goods or services from a certain store or location, the user may receive retailer- or producer-specific monetary rewards that are stored in a brand locker 572 associated with the user's mobile wallet account 524. Redeeming received monetary rewards is discussed further with regard to FIG. 9 below.

In another embodiment, as shown in FIG. 9, a method 900 is provided for redeeming a monetary reward received for participation in opt-in advertising an electronic payment system 521 receives a first indication from a user's mobile wallet application 511 that a user 507 is attempting to pay for a good 503 or service using one or more monetary rewards 577 received in exchange for participation in opt-in advertising 546, the user having a mobile wallet account 524 at the electronic payment system 521 (act 910). The electronic payment system then validates the user's mobile wallet account 524 to ensure that the user's mobile wallet account has sufficient funds, including the monetary rewards, to pay for the specified good 503 or service (act 920). Then, the electronic payment system 521 applies one or more of the monetary rewards 577 to the indicated good 503 or service, allowing the user 507 to purchase the indicated good or service using the received monetary rewards 577 (act 930).

In this manner, a user can redeem monetary rewards received for participation in opt-in advertising to purchase a product or service. In some embodiments, as mentioned above, the monetary rewards may be stored in a value store in the mobile wallet application. In such cases, the monetary rewards may be applied automatically as the user pays for the specified good or service using the mobile wallet application. The electronic payment system 521 may send a notification to the user and/or the provider of the good or service indicating that the monetary rewards were applied to the purchase of the indicated good or service. Thus, the user knows that the product or service was purchased (in whole or in part) using the monetary rewards, and the advertiser or goods producer 571 knows that monetary rewards were used to pay for their product or service.

As mentioned above, some advertisements may have web links or other interactive content. In such cases, the digital device 508 or the mobile wallet application 511 on the digital device may receive inputs from the user 507 interacting with the advertisements 546. The digital device may track the user's interaction, and may send an indication of such to the electronic payment system 521. The electronic payment system 521 may then determine that the user's interactions with the advertisements warrants conferring a specified monetary reward to the user. This monetary reward 577 may then be conferred to the user via the mobile wallet application 511. This monetary reward may be stored for a period of time, and later used to purchase a product or service.

In some cases, coupons or other rewards or offers (i.e. benefits 577) may be applied in addition to using any monetary rewards. Thus, coupons or rewards stored in the user's brand locker 572 may be applied to the purchase of a specified good or service. The electronic payment system 521 may determine that the coupon applies to the indicated good or service and then apply the coupon to the indicated good or service. As such, the user purchases the indicated good or service using the received monetary rewards at a price reduced by the amount of the coupon or other stored offer. The coupons and/or monetary rewards may be applied automatically when purchasing the coupon's corresponding product or service. In this manner, coupons, monetary rewards and/or other benefits 577 may be applied (automatically or selectively) when purchasing a product or service using a mobile wallet 511.

Embodiments of the invention can adhere to Know Your Customer (KYC) rules in the US by performing Customer Identification Program (CIP) checks as required by the Bank Secrecy Act and US PATRIOT Act. A minimum amount of information can be gathered about a customer, such as, for example, First Name, Last Name, Date of Birth, Government ID Type, Government ID Number, Address. The CIP processes are designed to validate customer identity against government blacklists and assists in the prevention of money laundering and terrorist financing. A combination of non-documentary and documentary verification can be used to ensure beyond a reasonable doubt the identity of the customer.

Non-Documentary Verification can occur through the presentment of the information that was collected from the user to an external third party, such as, for example, Lexis Nexis. Documentary Verification can occur if non-documentary verification fails, then the user is asked to present an unexpired government ID. Various differ forms of identification including Driver's license, Passport, Alien identification (e.g., green card or work visa), and Mexican Consular identification card, can be accepted.

Embodiments of the invention can perform Anti-Money Laundering (AML) and Combating the Financing of Terrorism (CFT) checks. AML and CFT checks can be performed using transaction monitoring methods to flag names and suspicious transactions for further investigation. The electronic payment system can perform AML and CFT checks on all electronic financial transactions to ensure that electronic funds are not being used for money laundering or terrorism. Transaction limits can be placed on user accounts. The transaction limits are fully configurable for each particular use case, channel and payment method that allows maximum flexibility to restrict higher risk use cases. Velocity checks can also be performed. Velocity Checks ensure that subscribers are not abusing the electronic payment system within the allowable limits.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. An electronic payment system comprising the following:
one or more processors;
system memory;
one or more computer-readable storage media having stored thereon computer-executable instructions that, when executed by the one or more processors, cause the electronic payment system to perform a method for providing monetary rewards in exchange for participation in opt-in advertising, the method comprising the following:
an act of receiving at the electronic payment system an indication that a user of is initiating participation in opt-in advertising sent from the electronic payment system in exchange for a monetary reward, the user having a mobile wallet account at the electronic payment system;
an act of sending one or more advertisements to a mobile wallet application running on a digital device of the user;
an act of determining an appropriate monetary reward based on at least one of the number and type of advertisements sent to the user's mobile wallet application; and
an act of providing the determined monetary reward to the user via the mobile wallet application on the user's digital device.

2. The electronic payment system of claim 1, further comprising an act of sending a message to the user's mobile wallet application to notify the user that the monetary reward is available.

3. The electronic payment system of claim 1, further comprising:
an act of receiving a list of items that a user has purchased using the mobile wallet account;
an act of analyzing the list of items to identify items or categories of items the user is likely interested in; and (along with other items purchased by the user)
an act of selecting the one or more advertisements corresponding to the determined items or categories of items.

4. The electronic payment system of claim 1, wherein the user opts in to receive a specified number of advertisements per time period.

5. The electronic payment system of claim 1, wherein the user provides an increased amount of personal data to receive an increased amount of monetary rewards.

6. The electronic payment system of claim 1, wherein monetary rewards are customized based on the user's current location.

7. The electronic payment system of claim 1, wherein one or more of the advertisements are sold at auction and wherein the user receives a specified percentage of the advertisement's selling price.

8. The electronic payment system of claim 1, wherein the digital device is a mobile telephone.

9. The electronic payment system of claim 1, wherein the digital device is a prepaid mobile telephone.

10. The electronic payment system of claim 1, wherein the user is an unbanked user.

11. The electronic payment system of claim 1, wherein the user receives retailer- or producer-specific monetary rewards that are stored in a brand locker associated with the user's mobile wallet account.

12. The electronic payment system of claim 1, wherein the indication further indicates the user's interest in certain products or types of products.

13. The electronic payment system of claim 1, wherein the indication further includes one or more portions of demographic information for the user.

14. An electronic payment system comprising the following:
one or more processors;
system memory;
one or more computer-readable storage media having stored thereon computer-executable instructions that, when executed by the one or more processors, cause the electronic payment system to perform a method for redeeming a monetary reward received for participation in opt-in advertising, the method comprising the following:
an act of receiving a first indication from a user's mobile wallet application that a user is attempting to pay for a good or service using one or more monetary rewards received in exchange for participation in opt-in advertising, the user having a mobile wallet account at the electronic payment system;
an act of validating the user's mobile wallet account to ensure that the user's mobile wallet account has sufficient funds, including the monetary rewards, to pay for the specified good or service; and
an act of applying one or more of the monetary rewards to the indicated good or service, allowing the user to purchase the indicated good or service using the received monetary rewards.

15. The electronic payment system of claim 14, wherein the one or more monetary rewards are stored in the mobile wallet application, and wherein the one or more monetary rewards are applied automatically as the user pays for the specified good or service using the mobile wallet application.

16. The electronic payment system of claim 14, further comprising:
an act of receiving one or more inputs from the user at the mobile wallet application interacting with one or more advertisements;
an act of determining that the user's interactions with the advertisements warrants conferring a specified monetary reward to the user; and
an act of conferring the specified monetary reward to the user.

17. The electronic payment system of claim 14, further comprising receiving an indication that the user has redeemed the conferred monetary reward.

18. The electronic payment system of claim 14, further comprising an act of sending a notification to at least one of the user and the provider of the good or service indicating that the one or more monetary rewards were applied to the purchase of the indicated good or service.

19. An electronic payment system comprising the following:
one or more processors;
system memory;
one or more computer-readable storage media having stored thereon computer-executable instructions that, when executed by the one or more processors, cause the computing system to perform a method for redeeming a monetary reward received for participation in opt-in advertising, the method comprising the following:
an act of receiving a first indication from a user's mobile wallet application that a user is attempting to pay for a good or service using one or more monetary rewards received in exchange for participation in opt-in advertising, the user having a mobile wallet account at the electronic payment system;
an act of validating the user's mobile wallet account to ensure that the user's mobile wallet account has sufficient funds, including the monetary rewards, to pay for the specified good or service;
an act of receiving a second indication from the user's mobile wallet application indicating that a coupon is to be applied for the purchase of the good or service;
an act of determining that the coupon applies to the indicated good or service; and
an act of applying the coupon to the indicated good or service, such that the user purchases the indicated good or service using the received monetary rewards at a price reduced by the amount of the coupon.

20. The electronic payment system of claim 19, wherein one or more coupons stored in a brand locker of the mobile wallet application are automatically applied when purchasing the coupon's corresponding product or service.
